(19) United States
(12) Patent Application Publication
(10) Pub. No.: US 2025/0117984 A1
(43) Pub. Date: Apr. 10, 2025

(54) METHOD AND DEVICE WITH IMAGE GENERATION

(71) Applicant: Samsung Electronics Co., Ltd., Suwon-si (KR)

(72) Inventors: Lu XU, Beijing (CN); Chao ZHANG, Beijing (CN); Yasi WANG, Beijing (CN); Hyong Euk LEE, Suwon-si (KR); Qiang WANG, Beijing (CN)

(73) Assignee: Samsung Electronics Co., Ltd., Suwon-si (KR)

(21) Appl. No.: 18/910,380

(22) Filed: Oct. 9, 2024

(30) Foreign Application Priority Data
Oct. 9, 2023 (CN) 202311303919.3
Sep. 4, 2024 (KR) 10-2024-0120169

(51) Int. Cl. G06T 11/00; G06T 7/40; G06T 7/50; G06T 7/90; G06V 10/74; G06V 10/77; G06V 10/774

(52) U.S. Cl. CPC G06T 11/001; G06T 7/40; G06T 7/50; G06T 7/90; G06V 10/74; G06V 10/7715; G06V 10/774; G06T 2207/20081; G06T 2207/20221

(57) ABSTRACT

A processor-implemented method with image generation includes obtaining a first image, determining predicted texture information of a target image corresponding to the first image through a texture prediction model, based on the first image, determining predicted color information of the target image through a color prediction model, based on the first image, and generating the target image based on the first image, using the predicted texture information and the predicted color information, wherein a format of the target image is different from that of the first image.

### CROSS-REFERENCE TO RELATED APPLICATIONS

This application claims the benefit under 35 USC § 119(a) of Chinese Patent Application No. 202311303919.3 filed on Oct. 9, 2023, in the China National Intellectual Property Administration, and Korean Patent Application No. 10-2024-0120169 filed on Sep. 4, 2024, in the Korean Intellectual Property Office, the entire disclosures of which are incorporated herein by reference for all purposes.

### BACKGROUND

### 1. Field

The following description relates to a method and device with image generation.

### 2. Description of Related Art

A portable mobile device may use a small sensor due to its strict size requirements, and an image collected by the mobile device may have an image quality that is relatively lower than one obtained by a mainstream device, such as, for example, a single-lens reflex (SLR) camera device. In such mobile terminal devices, image signal processing (ISP) for SLR images may replace a typical ISP strategy with a model designed to perform learning to reduce hardware-induced image quality differences. A mapping process may aim to improve an image quality while maintaining the content of an image itself intact. In mobile terminal devices, the ISP for SLR images may be defined as a matter of mapping from a raw image into a standard red, green, blue (sRGB) image and may also be defined as image reconstruction or image enhancement based on each image processing operation included in the mapping.

However, ISP from mobile to SLR quality may still face some challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with image generation includes obtaining a first image, determining predicted texture information of a target image corresponding to the first image through a texture prediction model, based on the first image, determining predicted color information of the target image through a color prediction model, based on the first image, and generating the target image based on the first image, using the predicted texture information and the predicted color information, wherein a format of the target image is different from that of the first image.

The determining of the predicted texture information of the target image through the texture prediction model, based on the first image, may include generating an encoded image feature of the first image by encoding the first image through a first encoder of the texture prediction model, generating a first predicted image by decoding the encoded image feature of the first image through a first decoder of the texture prediction model, and performing a texture extraction operation on the first predicted image through a texture extraction model to determine the predicted texture information of the target image.

The texture prediction model may be trained by generating an encoded image feature of training data by inputting the training data into the first encoder and encoding the training data, determining predicted texture information corresponding to the training data through the first decoder of the texture prediction model and determining predicted depth information through a second decoder of the texture prediction model, by inputting the encoded image feature into each of the first decoder and the second decoder, and training the first encoder and the first decoder through the predicted texture information corresponding to the training data and a reference image corresponding to the training data, and training the first encoder and the second decoder based on the determined predicted depth information and a depth map generated through a depth model, wherein the training data is of the same format as the first image, and the training data and the reference image are generated by different image sensors.

The depth map may be generated by performing relative depth estimation on an entire scene corresponding to the training data through the depth model and generating a depth map corresponding to the training data.

The determining of the predicted color information of the target image through the color prediction model, based on the first image, may include extracting a feature of the first image through a second encoder of the color prediction model, based on the first image, matching the feature of the first image with a discrete code table comprising a-priori information of a reference image, through the color prediction model, generating a second predicted image by reconstructing the matched feature through a third decoder of the color prediction model, and performing a color space transformation on the second predicted image and determining, to be the predicted color information, a color component of a result generated by the color space transformation.

The color prediction model may be trained by training the third decoder and the discrete code table based on the reference image, and training the second encoder through the trained discrete code table and the trained third decoder, based on training data, wherein the reference image and the training data are generated by different image sensors.

The training of the third decoder and the discrete code table based on the reference image may include extracting a feature of the reference image by inputting the reference image into the second encoder, matching the feature of the reference image with a previous discrete code table, and reconstructing the matched feature using the third decoder, and training the discrete code table and the third decoder based on the reference image and an image generated after the reconstructing.

The training of the second encoder through the trained discrete code table and the trained third decoder based on the training data may include extracting a feature of the training data by inputting the training data into the second encoder, matching the feature of the training data with the discrete code table determined by training, and reconstructing the matched feature using the third decoder determined by training, and training the third decoder based on a reference image corresponding to the training data and an image generated after the reconstructing.

The method may include obtaining semantic information of the reference image, and semantically matching the semantic information with a feature of the reference image that matches a previous discrete code table, wherein the reconstructing of the matched feature using the third decoder may include reconstructing a feature after the semantically matching using the third decoder.

The generating of the target image based on the first image using the predicted texture information and the predicted color information may include generating a first fused image by performing fusion processing on the predicted texture information and the predicted color information, determining a first exposure parameter through an exposure estimation model based on the first fused image, and performing an exposure adjustment on the first fused image based on the first exposure parameter to generate the target image.

The method may include generating an exposure-normalized first image by performing exposure normalization processing on the first image for each color channel, wherein the determining of the predicted texture information and the determining of the predicted color information are based on the exposure-normalized first image.

The method may include estimating a second exposure parameter from the first image through an exposure estimation model, wherein the generating of the target image based on the first image using the predicted texture information and the predicted color information may include generating an exposure-normalized third image based on the exposure-normalized first image, using the predicted texture information and the predicted color information, and performing an exposure adjustment on the exposure-normalized third image, using the second exposure parameter, to generate the target image.

In one or more general aspects, a non-transitory computer-readable storage medium may store instructions that, when executed by one or more processors, configure the one or more processors to perform any one, any combination, or all of operations and/or methods disclosure herein.

In one or more general aspects, an electronic device includes one or more processors configured to obtain a first image, determine predicted texture information of a target image corresponding to the first image and having a format different from that of the first image, through a texture prediction model, based on the first image, determine predicted color information of the target image through a color prediction model, based on the first image, and generate the target image based on the first image, using the predicted texture information and the predicted color information.

The one or more processors may be configured to, for the determining of the predicted texture information of the target image through the texture prediction model, based on the first image, generate an encoded image feature of the first image by encoding the first image through a first encoder of the texture prediction model, generate a first predicted image by decoding the encoded image feature of the first image through a first decoder of the texture prediction model, and perform a texture extraction operation on the first predicted image through a texture extraction module to determine the predicted texture information of the target image.

The one or more processors may be configured to, for the determining of the predicted color information of the target image through the color prediction model, based on the first image, extract a feature of the first image through a second encoder of the color prediction model, based on the first image, match the feature of the first image with a discrete code table comprising a-priori information of a reference image, through the color prediction model, generate a second predicted image by reconstructing the matched feature through a third decoder of the color prediction model, and perform a color space transformation on the second predicted image and determine, to be the predicted color information, a color component of a result obtained by the color space transformation.

The one or more processors may be configured to, for generating the target image based on the first image, using the predicted texture information and the predicted color information, generate a first fused image by performing fusion processing on the predicted texture information and the predicted color information, determine a first exposure parameter through an exposure estimation model based on the first fused image, and perform an exposure adjustment on the first fused image based on the first exposure parameter to generate the target image.

The one or more processors may be configured to generate an exposure-normalized first image by performing exposure normalization processing on the first image for each color channel, and for the determining of the predicted texture information and the determining of the predicted color information, determine the predicted texture information and determine the predicted color information based on the exposure-normalized first image.

In one or more general aspects, a processor-implemented method with image generation includes determining, based on a first image, predicted texture information of a target image corresponding to the first image and having a different format than the first image, using a texture prediction model, determining, based on the first image and a discrete code table predetermined based on a reference image of the second format, predicted color information of the target image, using a color prediction model, and generating the target image based on the predicted texture information and the predicted color information.

The method may include determining, based on the predicted texture information and the predicted color information, predicted exposure information of the target image, wherein the generating the target image further may include generating the target image based on the predicted exposure information.

Other features and aspects will be apparent from the following detailed description, the drawings, and the claims.

### BRIEF DESCRIPTION OF THE DRAWINGS

FIG. 1 shows an example standard red, green, blue (sRGB) image of a mobile terminal device and an example sRGB image of a single-lens reflex (SLR) camera device.

FIG. 2 shows an offset between an sRGB image of a mobile terminal device and an sRGB image of an SLR device.

FIG. 3 illustrates an image generation method according to one or more example embodiments.

FIG. 4 illustrates an overall conceptual process according to one or more example embodiments.

FIG. 5 illustrates an example of a framework for generating an SLR-quality image by performing image signal processing (ISP) by a mobile terminal device based on a depth and an SLR image a-priori guidance according to one or more example embodiments.

FIG. 6 illustrates a depth of field (DOF) of a mobile terminal device and a DOF of an SLR device that are different.

FIG. 7 illustrates an example of a texture prediction process according to one or more example embodiments.

FIG. 8 illustrates an example of a texture prediction result and a comparative example thereof according to one or more example embodiments.

FIG. 9 illustrates an example of a color prediction process according to one or more example embodiments.

FIG. 10 illustrates an example of a curve-based exposure adjustment process for a red, green, blue (RGB) image.

FIG. 11 shows adjustment results corresponding to different exposure prediction parameters.

FIG. 12 illustrates an example of a curve-based exposure adjustment process for an input raw domain image.

FIG. 13 shows color prediction results according to one or more example embodiments.

FIG. 14 illustrates an example of an electronic device according to one or more example embodiments.

FIG. 15 illustrates an example of an electronic system according to one or more example embodiments.

FIG. 16 illustrates an example of an electronic device according to one or more example embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of embodiments, detailed description of structures or functions that are thereby known after an understanding of the disclosure of the present application will be omitted when it is deemed that such description will cause ambiguous interpretation of the embodiments.

Although terms such as “first,” “second,” “A,” “B,” “(a),” and “(b)”, and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Components included in one embodiment, and components having common features, are described using the same designations in other embodiments. Unless otherwise indicated, the description of one embodiment applies to the other embodiments, and a detailed description thereof is omitted when it is deemed redundant.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

To generate a standard red, green, blue (sRGB) image, a depth of field (DOF) that is different for each hardware device or an exposure difference that varies depending on a scene being captured may need to be considered. Compared to a mainstream single-lens reflex (SLR) device, a camera on a mobile device may have a smaller blur circle and a wider DOF range, and thus an image captured by the mobile device may be sharper in most cases. This may be inconsistent with an imaging rule of the SLR device, and there may thus be a large difference in texture distribution between a generated SLR-quality image and an actual SLR image. In addition, an exposure result may differ for the same scene depending on a hardware device and an imaging environment. Further, an imaging color of the SLR device may be affected by unknown factors such as an intrinsic device characteristic and an environment, and directly predicting a color may lead to an inaccurate mapping result.

Therefore, better simulating a sharpness-blur distribution while predicting a color distribution that is more approximate to that of the SLR device may be required.

Typically, image signal processing (ISP) may include a series of operations ranging from image demosaicing and image denoising of a low-level vision to color correction of a high-level vision, or the like. A typical strategy may be to perform each operation independently to convert a raw image into an sRGB image. Although completing ISP through an end-to-end model may be challenging, the present disclosure may bridge an imaging quality gap caused by hardware limitations in an ISP process from a raw image collected by a mobile terminal device to an sRGB image of a camera quality.

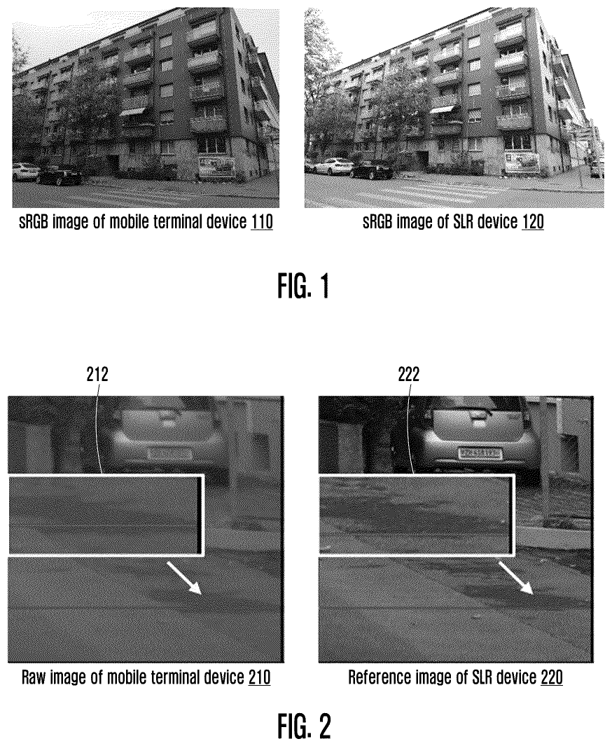

FIG. 1 shows an example sRGB image of a mobile terminal device and an example sRGB image of an SLR camera device. The mobile terminal device may also be interchangeably used herein as a mobile terminal and/or a mobile device, and the SLR camera device may also be interchangeably used herein as an SLR camera and/or an SLR device.

As shown in FIG. 1, comparing an sRGB image 110 collected by a mobile terminal device and an sRGB image 120 collected by an SLR device, an imaging result from the sRGB image 120 collected by the SLR device may be affected by an ISP algorithm of the device itself, in addition to an influence of an unknown image-capturing environment during a mapping process. On the one hand, images collected by different devices may have an unknown color mapping relationship therebetween. In addition, the mobile terminal device and the mainstream SLR device may have different DOFs, which may be affected by their hardware properties.

FIG. 2 shows an offset between an sRGB image of a mobile terminal device and an sRGB image of an SLR device.

In an actual model designing process, there may be a problem of spatial misalignment in existing data. Typically, for correlation data, a pair of image data obtained from the same scene may be collected using different devices, and there may be no guarantee that collected results are spatially aligned. In this case, using such inaccurately aligned data to perform supervised learning, there may be problems such as pixel offsets and blurs in the results. An example of such data misalignment is shown in FIG. 2. Comparing an enlarged area of a rectangular box 212 in a raw image 210 of a mobile terminal device and an enlarged area of a rectangular box 222 in a reference image 220 of an SLR device, there may be a distinct offset problem.

Hereinafter, example embodiments of the present disclosure will be described with reference to the accompanying drawings.

Although the example embodiments are described herein using a raw image of a mobile terminal device and an SLR image as examples, examples are not limited to the raw image and the SLR image, and other images of different sensors with different image formats and/or image domains may also be used.

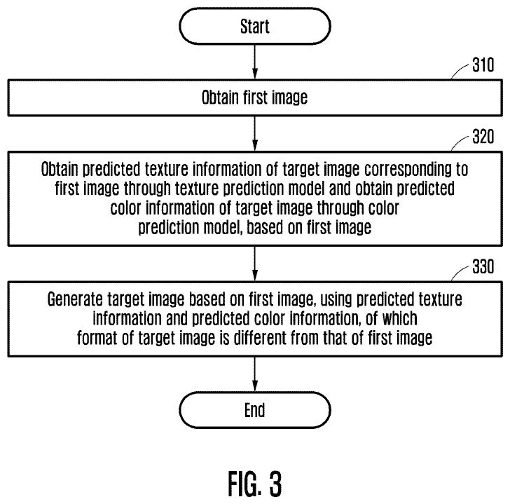

FIG. 3 illustrates an image generation method according to one or more example embodiments. Operations 310 to 330 to be described hereinafter may be performed sequentially in the order and manner as shown and described below with reference to FIG. 3, but the order of one or more of the operations may be changed, one or more of the operations may be omitted, and two or more of the operations may be performed in parallel or simultaneously without departing from the spirit and scope of the example embodiments described herein.

Referring to FIG. 3, at operation 310, the image generation method may obtain (e.g., generate) a first image.

At operation 320, the image generation method may, based on the first image, obtain predicted texture information of a target image corresponding to the first image through a texture prediction model and obtain predicted color information of the target image through a color prediction model. In this case, the format of the target image may be different from the format of the first image.

At operation 330, the image generation method may generate the target image based on the first image, using the predicted texture information and the predicted color information.

According to an example embodiment, the first image may be a raw domain image of a mobile terminal, and the target image may be an SLR image in an RGB format. However, examples are not limited thereto. For example, the first image and the target image may be images having different formats, different spatial domains, and/or different color domains.

According to an example embodiment, the image generation method of one or more embodiments may predict texture information and color information of the target image to more effectively simulate a sharpness-blur distribution of the target image and simultaneously predict a color distribution that is more approximate to a target device.

According to an example embodiment, a texture prediction and a color prediction may be performed in parallel or sequentially, and the order in which the texture prediction and the color prediction are performed may be determined as needed.

In the description of the present disclosure, the terms “depth of field (DOF)” and “depth” may be used interchangeably at times.

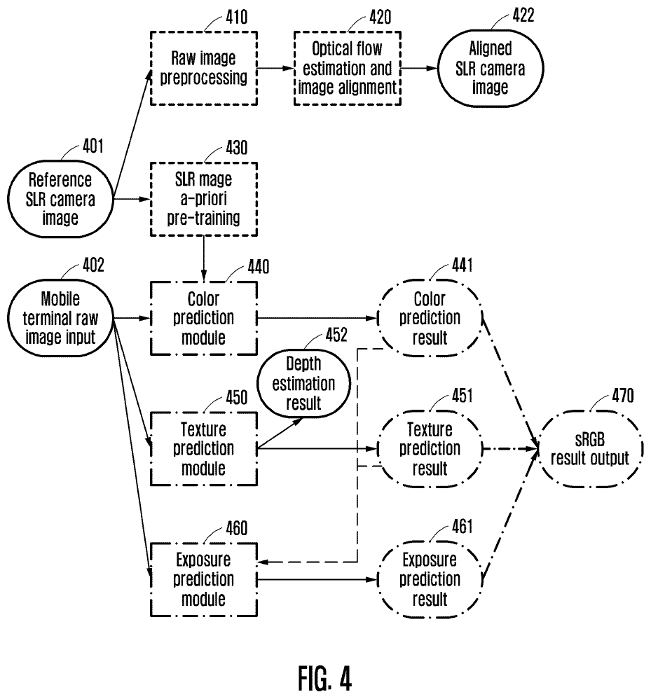

FIG. 4 illustrates an overall conceptual process according to one or more example embodiments.

As shown in FIG. 4, the overall process may include performing, on a reference SLR camera image 401, raw image preprocessing 410 and optical flow estimation and image alignment 420 to generate an aligned SLR camera image 422; and performing SLR image a-priori pre-training 430 on the reference SLR camera image 401 to generate a discrete code table.

This process may include receiving a raw image 402 of a mobile terminal and performing ISP based on a depth and the discrete code table from the SLR image a-priori pre-training 430 to output an sRGB result 470 that is an SLR-quality image. The process described with reference to FIG. 4 may also include a color prediction module 440 and a texture prediction module 450.

The color prediction module 440 may predict a color of a target SLR image based on the input raw domain image 402 of the mobile terminal and the discrete code table to output a color prediction result 441.

The texture prediction module 450 may estimate a detailed texture distribution of the target SLR image based on the input raw domain image 402 of the mobile terminal to output a texture prediction result 451. In an example, the texture prediction module 450 may also estimate a depth of the target SLR image based on the input raw domain image 402 of the mobile terminal to output a depth estimation result 452.

The color prediction module 440 and the texture prediction module 450 described above with reference to FIG. 4 may be executed at operation 320 described above with reference to FIG. 3.

In addition, the process described with reference to FIG. 4 may further include an exposure prediction module 460.

To ensure that a generated image is more approximate to the target SLR image, the image generation method of one or more embodiments may remove an exposure difference by different image scenarios and apply the exposure prediction module 460 to simulate an exposure situation of the target image.

The exposure prediction module 460 may output an exposure prediction result 461 by estimating an exposure of the target SLR image based on the color prediction result 441 and the texture prediction result 451, which are initial results of the color prediction and the texture prediction, and/or based on the input raw domain image 402 of the mobile terminal.

The process described with reference to FIG. 4 may generate the sRGB result 470 that is an SLR-quality image corresponding to the target image of the raw domain image 402 of the mobile terminal, using the color prediction result 441, the texture prediction result 451, and the exposure prediction result 461.

According to an example embodiment, one or more of the color prediction module 440, the texture prediction module 450, and the exposure prediction module 460 may be implemented using various neural networks.

The process described above with reference to FIG. 4 may be implemented by a deep neural network (DNN).

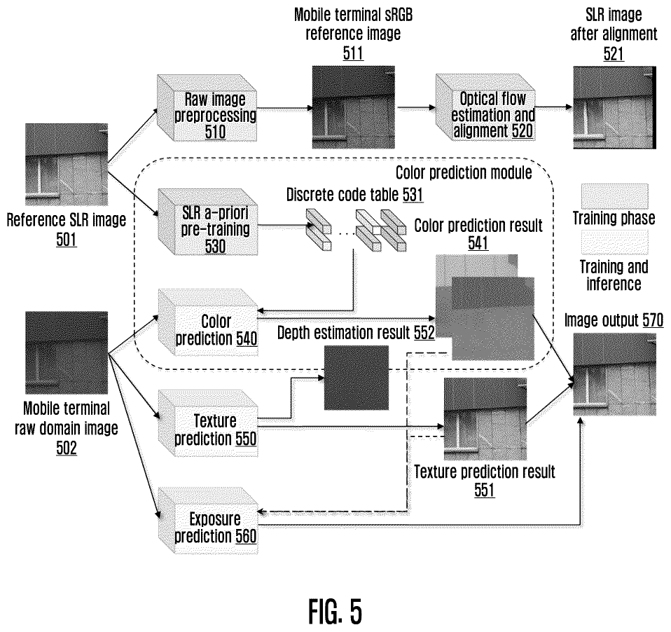

FIG. 5 illustrates an example of a framework for generating an SLR-quality image by performing ISP by a mobile terminal device based on a depth and an SLR image a-priori guidance according to one or more example embodiments.

According to an example embodiment, the framework may be divided into a training phase and an inference phase.

The training phase may include: raw image preprocessing 510, optical flow estimation and alignment 520, and SLR a-priori pre-training 530. The inference phase may include a color prediction 540, a texture prediction 550, and an exposure prediction 560.

In the training phase, the raw image preprocessing 510 may be performed on a reference SLR image 501 to generate a reference sRGB image 511 of a mobile terminal, and the optical flow estimation and alignment 520 may be performed on the reference sRGB image 511 of the mobile terminal to obtain an aligned SLR image 521.

In the training phase, the SLR image a-priori pre-training 530 may be performed on the reference SLR image to learn a discrete code table 531 including SLR image a-priori information, which is to be used for a color prediction.

In the training phase, the aligned SLR image 521 may be used to train a color prediction model (e.g., a color prediction model implemented by the color prediction module 440 of FIG. 4).

In the training phase, the aligned SLR image 521 and a reference depth map may be used to train a texture prediction model (e.g., a texture prediction model implemented by the texture prediction module 450 of FIG. 4).

In the inference phase, a raw domain image 502 of the mobile terminal and the discrete code table 531 may be used as inputs to obtain a color prediction result 541 through the color prediction 540.

In the inference phase, the raw domain image 502 of the mobile terminal may be used as an input to obtain a texture prediction result 551 through the texture prediction 550.

In the inference phase, the color prediction result 541 and the texture prediction result 551 may be combined to obtain an SLR-quality sRGB image 570.

In the inference phase, the raw domain image 502 of the mobile terminal or the color prediction result 541 and the texture prediction result 551 may be used as an input to obtain the sRGB image 570 of an image quality that is more approximate to that of an SLR device through the exposure prediction 560.

Hereinafter, examples of the texture prediction 550, the color prediction 540, and the exposure prediction 560 will be described in detail with reference to the accompanying drawings.

According to an example embodiment, the texture prediction 550 may predict a texture based on a depth. In this case, a depth-based texture prediction module may estimate a texture distribution of a target image based on the raw domain image 502 of the mobile terminal and obtain a depth estimation result 552 using a single image depth estimation method.

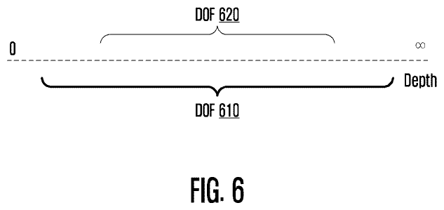

A mobile terminal device and a mainstream SLR device may typically have different DOFs due to different hardware conditions. The mobile terminal device may typically have a smaller blur circle due to size constraints, such as, a smaller sensor size and a compact lens size, and may therefore have a wider DOF range. In contrast, the mainstream SLR device may have a larger blur circle and may therefore have a smaller DOF range, as shown in FIG. 6.

FIG. 6 illustrates a DOF of a mobile terminal device and a DOF of an SLR device that are different.

A DOF of an image may be related to a depth of a scene. For example, in a case where a depth of a current area is within a DOF, a device may capture a sharp image. Therefore, in most scenes, an imaging result from a mobile terminal device 610 may be sharper than a result from an SLR camera 620. In the imaging result from the SLR camera 620, which is affected by a DOF range, a main target object may be processed to be sharp, and the background may be processed to be blurred, which may be more suitable for a visual habit of the human eyes. Therefore, in a process of one or more embodiments of image mapping from the mobile terminal device 610 to the SLR camera 620, by accurately simulating a blurring effect of the SLR camera 620, the process of one or more embodiments may further improve an image quality of a mapping result from the process of image mapping.

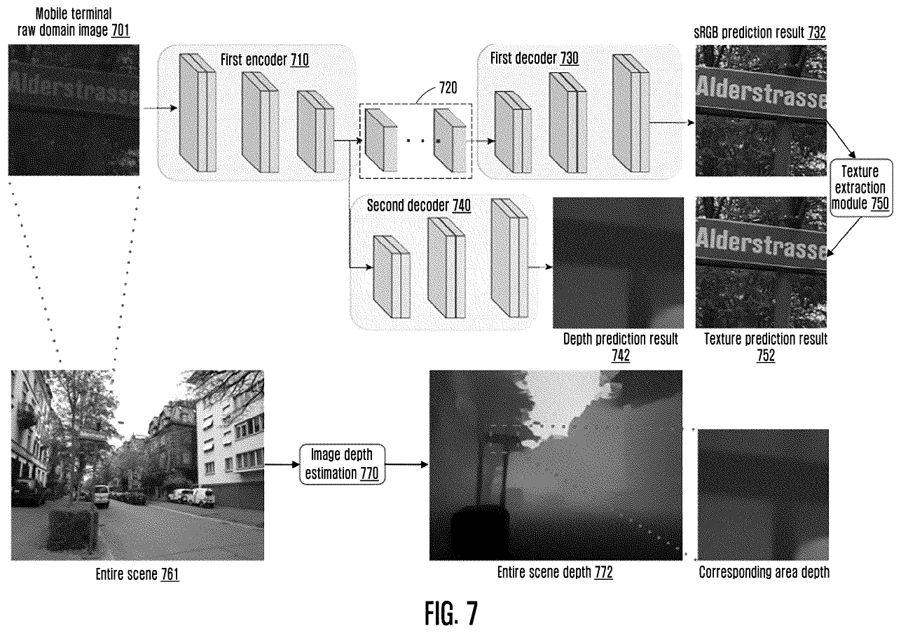

FIG. 7 illustrates an example of a texture prediction process according to one or more example embodiments. The texture prediction process may be performed by a texture prediction model (e.g., a texture prediction model implemented by the texture prediction module 450 of FIG. 4).

According to an example embodiment, the texture prediction process may encode a first image (e.g., a raw domain image 701 of a mobile terminal) through a first encoder 710 (e.g., a shared encoder) to obtain an encoded image feature. The texture prediction process may decode the encoded image feature through a first decoder 730 (e.g., a texture decoder) to obtain a first predicted image (e.g., a predicted sRGB image) corresponding to an sRGB prediction result 732. The texture prediction process may then perform a texture extraction operation on the first predicted image through a texture extraction module 750 to obtain predicted texture information corresponding to a texture prediction result 752.

For example, for the input raw domain image 701 (i.e., the first image) of the mobile terminal, the first encoder 710 (e.g., the shared encoder) may encode it to obtain a corresponding encoded image feature. A second decoder 740 (e.g., a depth decoder) may use, as an input, the encoded image feature output from the first encoder 710 and reconstruct a corresponding scene depth from the encoded image feature to obtain a depth prediction result 742. In addition, the first decoder 730 (e.g., the texture decoder) may use, as an input, a feature obtained after passing through an intermediate layer 720 based on the encoded image feature output from the first encoder 710 and may decode it to obtain the first predicted image corresponding to the corresponding sRGB prediction result 732.

The texture prediction process may then transform a color space of the first predicted image corresponding to the sRGB prediction result 732 and extract texture information corresponding to the texture prediction result 752 to obtain corresponding predicted texture information.

For example, the texture prediction process may perform the texture extraction operation on the first predicted image (e.g., the predicted sRGB image) through the texture extraction module 750 to obtain the predicted texture information.

According to an example embodiment, the texture extraction module 750 may implement a texture prediction model or may use, as an input, an output of the texture prediction model, e.g., a result output based on the texture prediction model.

In a training phase of the texture prediction model, the texture prediction process may input training data into the first encoder 710 and encode the training data to obtain an encoded image feature of the training data, and may input the encoded image feature into the first decoder 730 (e.g., the texture decoder) and the second decoder 740 (e.g., the depth decoder) to obtain predicted texture information through the first decoder 730 and obtain predicted depth information through the second decoder 740. Using the obtained predicted texture information of the training data and a reference image corresponding to the training data, the first encoder 710 and the first decoder 730 may be trained. Using the obtained predicted depth information of the training data and a depth map obtained through a depth model, the first encoder 710 and the second decoder 740 may be trained. In this case, the training data and the reference image may be images obtained through different image sensors. Additionally, the training data may be of the same format as the first image.

The texture prediction process may perform image depth estimation 770 to estimate a relative depth in an entire scene 761 corresponding to the training data, through the depth model, to obtain a depth map 772 corresponding to the training data.

For example, the training data may be raw domain image data, and the reference image may be an SLR image.

Further, in the training phase, the texture prediction process may perform image relative depth estimation on an entire scene corresponding to a raw domain image to obtain a depth map corresponding to the input raw domain image, and may use the depth map as a pseudo-label for depth prediction in a subsequent training process to train the first encoder 710 and the second decoder 740.

In this case, such a relative depth estimation function may obtain a depth relationship between objects in an image. For example, the relationship may indicate that the two objects are “close or near” or “remote or far” to or from each other.

In the texture prediction process, a main operation may be to predict an sRGB image using, as an input, the raw domain image 701 of the mobile terminal, and a secondary operation may be to learn a DOF-related feature through depth estimation of a single image and simulate a second image (e.g., a texture sharpness-blur distribution of an SLR image). The secondary operation may be trained in conjunction with the main operation to restrict the texture prediction model during an encoding step to learn and obtain the depth-related feature. Through this, the texture prediction process of one or more embodiments may contribute to a better prediction of various DOFs and corresponding sharpness-blur distributions. The secondary operation may be used only in the training phase, in an example.

According to an example embodiment, the first decoder 730 (e.g., the texture decoder) and the second decoder 740 (e.g., the depth decoder) may share the coded image feature output from the first encoder 710 (e.g., the shared encoder) to allow the texture prediction to learn depth information, and the depth prediction result 742 may affect the texture prediction result 752 accordingly.

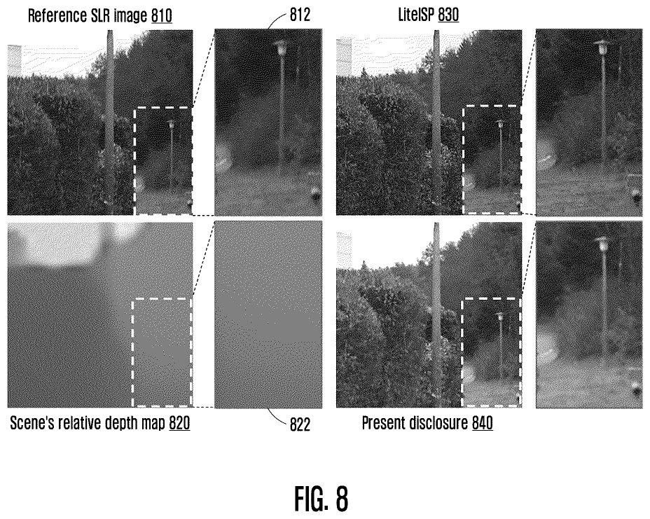

FIG. 8 illustrates an example of a texture prediction result and a comparative example thereof according to one or more example embodiments.

A scene 812 of a reference SLR image 810 may have a large depth that is out of a DOF range, as shown in a corresponding scene 822 of a relative depth map 820, which is a corresponding depth map, and may thus have a relatively blurry final imaging result. In contrast, an image of a mobile terminal may have a large DOF range, and thus an ISP result obtained without considering the depth may be sharper than the reference SLR image 810, as shown in a lite camera ISP result (e.g., LiteISP 830) in a comparative example. The method of one or more embodiments, combined with depth estimation, may effectively estimate a DOF range of a scene, and a final ISP result may be more approximate to a reference SLR image.

For a texture prediction model, a loss may include a depth prediction loss and a texture prediction loss.

The depth prediction loss may be an L₁ loss, or Lₗ₁, of a predicted depth and a reference depth.

The texture prediction loss may be an L₁ loss between a generated image and an SLR image, a perceptual loss L_{perceptual}, a structural similarity index (SSIM) loss L_{SSIM}, and a generative adversarial loss L_{adv}.

Therefore, a loss function of the texture prediction model may be expressed as Equation 1 below, for example.

$${Loss}_{t e x t u r e} = {L}_{l 1} ( {Depth}_{predict} , {Depth}_{reference} ) + {α}_{1} {L}_{l 1} ( {t}_{o u t} , t ) + {β}_{1} {L}_{p e r c e p t u a l} ( {t}_{o u t} , t ) + {γ}_{1} {L}_{SSIM} ( {t}_{o u t} , y ) + {ε}_{1} {L}_{a d v} ( {t}_{o u t} ) \qquad Equation l :$$

In Equation 1, Depth_{predict} denotes a depth prediction result obtained by a depth decoder, Depth_{reference} denotes a reference depth image, tₒᵤₜ denotes a generated image of the texture prediction model, y denotes an SLR image, t denotes time, and α₁, β₁, γ₁, and ε₁ denote coefficients of the L1 loss, the perceptual loss L_{perceptual}, the SSIM loss L_{SSIM}, and the generative adversarial loss L_{adv}, respectively.

Alternatively, α₁, β₁, γ₁, and ε₁ may be obtained empirically or through simulation, but the values thereof are not limited to the examples described above.

According to an example embodiment, a color prediction may be based on an a-priori color prediction, for example, the a-priori color prediction may be based on a second image (e.g., an SLR image that serves as a reference image for a target image). A discrete code table obtained through training after a pre-training step in a color prediction model may be referred to as a-priori information of the SLR image (or “SLR image a-priori information” herein). The a-priori information may be regarded as including SLR image distribution information that includes color component information of the SLR image.

An a-priori SLR image-based color prediction module may estimate a color of a target image based on a current raw domain image of a mobile terminal.

There may be an unknown color mapping relationship between the input raw domain image of the mobile terminal and the target SLR sRGB image, which may be affected by various unknown factors, such as, camera parameters and an image-capturing environment. Therefore, it may be difficult for a typical method to accurately predict a target color directly based on the input raw domain image.

In contrast to the typical method, according to an example embodiment, to estimate a color distribution of a target SLR image, a discrete code table that is based on an SLR image may be formed through pre-training, and the discrete code table may include a-priori information of the SLR image for storing a feature matrix of the SLR image. Meanwhile, the pre-training may be performed to obtain a color decoder which may decode features corresponding to the code table to obtain an sRGB image.

Further, according to an example embodiment, a feature may be extracted from an input raw domain image and matched with a discrete code table of an SLR image to obtain a color prediction result that includes graphical content of a raw domain and a color distribution of the SLR image.

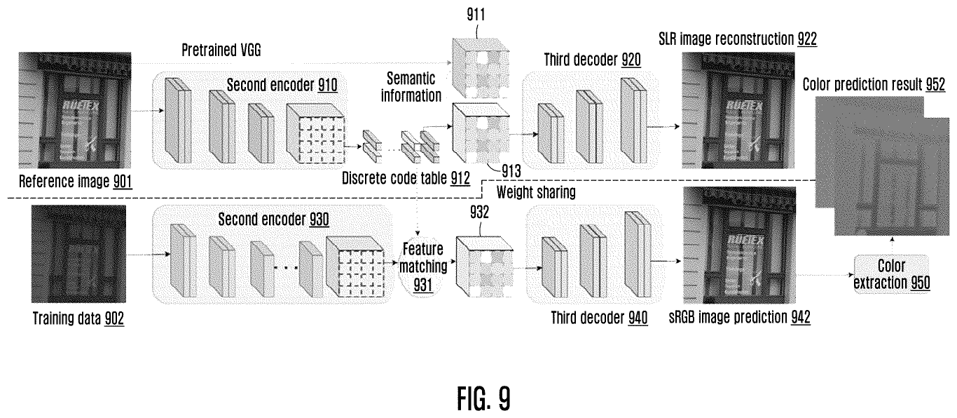

FIG. 9 illustrates an example of a color prediction process according to one or more example embodiments. The color prediction process may be in a training phase.

Hereinafter, an example of the process will be described in detail with reference to FIG. 9.

As shown in FIG. 9, according to an embodiment, a process of training a color prediction model may be largely divided into two steps.

In a first training step, a third decoder 920 corresponding to a discrete code table 912 may be pre-trained based on a reference image 901 (e.g., a reference SLR image). In the pre-training, the reference image 901 may be used as an input to perform matching with the discrete code table 912 to obtain a discrete code table for an SLR image. For example, the reference image 901 may be encoded through a second encoder 910 (e.g., an SLR image encoder) to obtain a feature of the SLR image, and the feature of the reference image may be matched with the previous discrete code table 912. A matching result 913 may be decoded by the third decoder 920 (e.g., a color decoder) to reconstruct the SLR image at operation 922. Based on the reference image 901 and an image obtained by the reconstruction, a training process for the discrete code table 912 and the third decoder 920 may be implemented. An obtained weight of the third decoder 920 may be used for a third decoder 940 in the same color prediction step as the third decoder 920.

In the first training step, an initial discrete code table may be obtained empirically or by random initialization, but the initial discrete code table may not be limited thereto.

In a second training step, based on training data 902 (e.g., a mobile terminal raw domain image collected by a mobile terminal device), a second encoder 930 may be trained using the discrete code table 912 and the third decoder 920 that are trained in the first training step. For example, the training data 902 may be input to the second encoder 930, and a feature of the training data 902 may be extracted and matched with the discrete code table 912 obtained from the training at operation 931. A matched feature 932 may be reconstructed using the third decoder 940 obtained by the training. The third decoder 940 may be trained based on the reference image 901 corresponding to the training data 902 and an image obtained after the reconstruction.

The reference image 901 and the training data 902 may be images obtained by different image sensors.

In addition, to further improve a correlation between a color prediction result and image's semantic information, semantic information 911 may be introduced as a guide for training in the first training step. A semantic guidance process may be implemented to narrow a distance between the semantic information 911 of the reference image extracted by a pre-trained model and the feature 913 of the SLR image obtained after the feature matching.

As shown in FIG. 9, the semantic information 911 of the reference image may be obtained through a pre-trained visual geometry group (VGG) network, and semantic matching may be performed on a feature of the reference image that is matched with the previous discrete code table, and a feature after the semantic matching may be input to the third decoder 920 for reconstruction.

Subsequently, according to an example embodiment, in an inference step in the color prediction, based on a first image, a feature of the first image may be extracted through the second encoder 930 of a color prediction model such as a color prediction encoder, and the extracted feature of the first image extracted through the color prediction model and the discrete code table 912 including a-priori information of the reference image may be matched at operation 931. The matched feature 932 may be reconstructed through the third decoder 940 of the color prediction model to generate a second predicted image (e.g., a predicted sRGB image 942), and a color space transformation may be performed on the second predicted image. Of a result obtained by the color space transformation through color extraction 950, a color component may be determined to be predicted color information and output as a color prediction result 952.

For example, a feature of an input raw domain image may be extracted by the second encoder 930. For example, the raw domain image may be encoded through a color prediction encoder (i.e., the second encoder 930), and its feature/information may be extracted. The color prediction model may match the feature/information extracted through the second encoder 930 to a discrete code table of an SLR image. The matched feature may be reconstructed by a color decoder (i.e., the third decoder 940) to generate a second predicted image (e.g., an sRGB predicted image). The third decoder 920 in the pre-training step may share parameters (e.g., weights) with the third decoder 940 in the prediction step. In the corresponding color prediction step, a weight of the third decoder 940 corresponding to the pre-trained discrete code table may be fixed.

Finally, the obtained predicted sRGB image may be transformed into a color space, and color information corresponding to that color may be extracted at operation 950 to preserve a color component to obtain a final color prediction result 952 (e.g., the predicted color information). For example, the color space transformation into a YCrCb space may preserve Cr and Cb components. However, examples of color spaces are not limited thereto.

According to an example embodiment, the color space transformation may be performed by the color prediction model, or may be performed outside the color prediction model or through an output to the color prediction model.

For example, a-priori SLR image-based color prediction module may include the following four steps.
(1) Pre-training a discrete code table and a corresponding decoder based on an SLR image;
(2) Performing feature extraction and feature matching on a raw domain image;
(3) Reconstructing a matched feature by the decoder to generate a predicted sRGB result; and
(4) Performing a color space transformation on the predicted sRGB image to preserve its color component

For the color prediction model, a loss function of the pre-training step may be expressed as Equation 2 below, for example.

$${Loss}_{p r e t r a i n} = {L}_{l 1} ( {y}_{r e c o n} , y ) + {α}_{2} {L}_{l 2} ( s g ( z e ) , z c ) + {β}_{1} {L}_{l 2} ( s g ( z e ) , z c ) + {γ}_{2} {L}_{l 2} ( z c , v g g ( y ) ) \qquad Equation 2 :$$

In Equation 2, Lₗ₂ denotes an L2 loss, sg( ) denotes a gradient stop operation, y_{recon} denotes an SLR image reconstructed by a decoder, ze denotes an encoder output feature, zc denotes a feature after matching, vgg(y) denotes a semantic feature extracted from the input SLR image by a pre-trained VGG model, and α₂, β₂, and γ₂ denote coefficients of L1 loss and L2 loss, respectively, which may be obtained empirically.

In the prediction step, the loss function may be expressed as Equation 3 below, for example.

$${Loss}_{c o l o r} = {L}_{l 2} ( {z}_{m o b i l e} , {z}_{d s l r} ) + {α}_{3} {L}_{l 1} ( {c}_{o u t} , y ) + {β}_{3} {L}_{p e r c e p t u a l} ( {c}_{o u t} , y ) + {γ}_{3} {L}_{p e r c e p t u a l} ( {c}_{o u t} , y ) \qquad Equation 3 :$$

In Equation 3, Z_{mobile}, Z_{dslr} denotes a feature after matching a mobile terminal image and an SLR image, cₒᵤₜ denotes a generated image of the color prediction model, y denotes the SLR image, and α₃, β₃, and γ₃ denote coefficients of an L1 loss, a perceptual loss L_{perceptual}, and a generative adversarial loss L_{adv}, respectively.

Alternatively, α₃, γ₃, and γ₃ may be obtained empirically or through simulation, but the values thereof are not limited to the example described above.

As described above, an image exposure result collected by a device may be affected by various factors, such as, for example, an exposure method, a lighting condition of a scene at the time of image-capturing, or the like. Therefore, even if the same scene is captured, there may be a large exposure difference between image-capturing results of different devices. Therefore, to further improve a quality of a generated image and make it more approximate to an SLR image, the method of one or more embodiments may further perform an exposure prediction before obtaining a final target image.

According to an example embodiment, two exposure strategies—an exposure adjustment for an RGB image and an exposure adjustment for an input raw domain image—may be provided herein.

The exposure adjustment for an RGB image may be performed on an initial ISP result (i.e., a result of fusing a color prediction and a texture prediction that is not adjusted by exposure).

For example, according to an example embodiment, an exposure adjustment curve may be predicted to achieve the exposure adjustment, and such a prediction process may depend solely on an input initial ISP result, i.e., a result of fusing a color prediction and a texture prediction that is not adjusted by exposure. In the exposure adjustment process, preventing information loss from an overflow of image pixel values may need to be considered on one hand, and maintaining the original image content to be unchanged may need to be considered on the other hand.

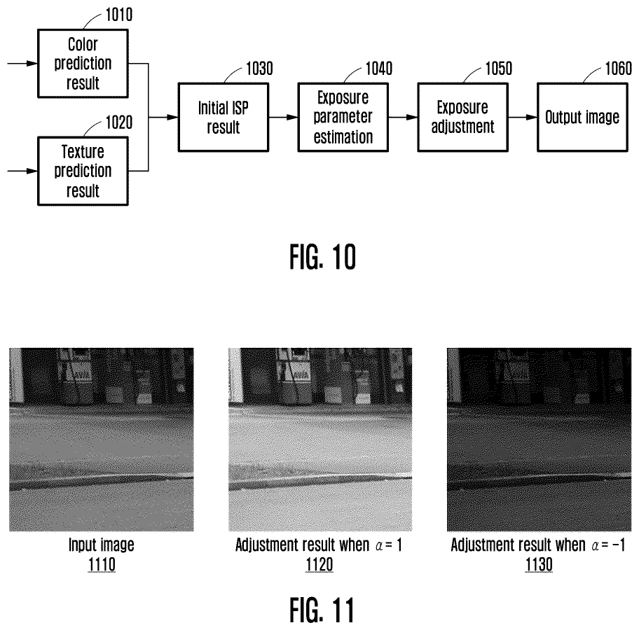

FIG. 10 illustrates an example of a curve-based exposure adjustment process for an RGB image.

The exposure adjustment process may be performed by an exposure adjustment module.

As shown in FIG. 10, the exposure adjustment process may fuse a color prediction result 1010 and a texture prediction result 1020 at an initial stage to obtain, as an input, an initial fused image, i.e., an initial ISP result 1030. The exposure adjustment process may then estimate a first exposure parameter α₄ according to the input image (e.g., the initial ISP result 1030) at operation 1040, and perform an exposure adjustment 1050 on the initial ISP result 1030 according to the first exposure parameter α₄ to obtain an output image corresponding to a target image. In this process, the exposure adjustment may be expressed as Equation 4 below, for example.

$$\begin{matrix}{I}_{o} = {I}_{i} + {α}_{4} {I}_{i} ( 1 - {I}_{i} ) & {α}_{4} ∈ [ - 1 , + 1 ]\end{matrix} \qquad Equation 4 :$$

In Equation 4, Io denotes an output image after the exposure adjustment, α₄ denotes a model-predicted first exposure coefficient, and Iᵢ denotes an initial fusion result of a color prediction and a texture prediction.

FIG. 11 shows adjustment results corresponding to different exposure prediction parameters and shows, for example, exposure results in two extreme cases.

In some application scenarios, an exposure relationship between image data collected by a mobile terminal and image data collected by a camera device may be unclear. Therefore, according to an example embodiment, to predict a more accurate image, the method of one or more embodiments may apply a curve-based exposure estimation model to adjust an exposure of an input raw domain image.

Referring to FIG. 11, it may be verified that, as an exposure a is adjusted, the brightness of an image may be adjusted.

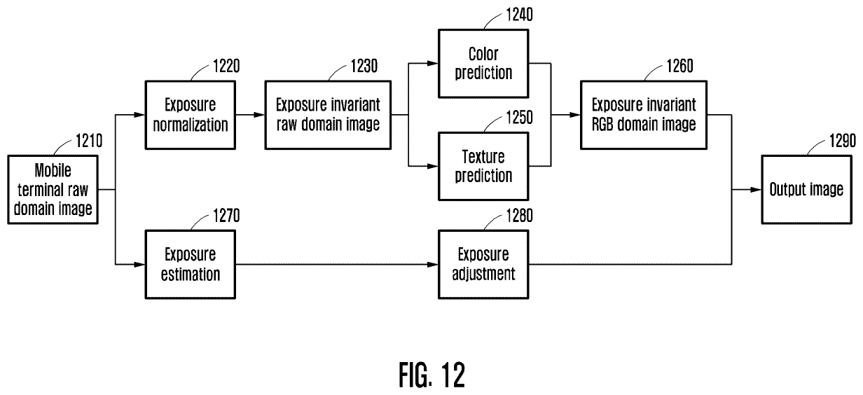

FIG. 12 illustrates an example of a curve-based exposure adjustment process for an input raw domain image. The exposure adjustment process may be performed by an exposure adjustment module.

Compared to the exposure adjustment for an RGB image shown in FIG. 10, the exposure adjustment model proposed here for an input raw domain image may use, as an input, a raw domain image (e.g., a first image) of a mobile terminal, and perform the exposure adjustment by directly performing exposure estimation on the raw domain image of the mobile terminal, thereby not being affected by an initial ISP result.

As shown in FIG. 12, the exposure adjustment process may perform exposure normalization 1220 on each color channel of a raw domain image 1210, i.e., a first image, of a mobile terminal before performing a texture prediction 1250 and a color prediction 1240 to obtain an exposure-normalized first image 1230 (e.g., an exposure-invariant raw domain image), which may be used as an input for the color prediction 1240 and the texture prediction 1250. In this case, the exposure normalization may be expressed as Equation 5 below, for example.

$$\begin{matrix}{I}_{n} = Norm ( {I}_{n} ) & n ∈ ( R , G , B )\end{matrix} \qquad Equation 5 :$$

For example, the exposure normalization may normalize three color channels (e.g., R, G, and B) of an image to reduce an image deviation in exposure.

In addition, the exposure adjustment process may obtain the first image through the texture prediction 1250 and the color prediction 1240 after performing the texture prediction 1250 and the color prediction 1240, i.e., an exposure-normalized third image 1260 (e.g., an exposure-invariant RGB domain image). In this case, the exposure-normalized third image 1260 (e.g., the exposure-invariant RGB domain image) may be an RGB domain image.

On the other hand, a second exposure parameter may directly target the first image (e.g., the raw domain image 1210 of the mobile terminal) to perform exposure estimation 1270 using an exposure estimation model. In this case, the second exposure parameter, or as, may be estimated from the first image, and similarly, α₅ may be a model-predicted exposure coefficient, and α₅∈[−1, +1].

The exposure adjustment process may then perform exposure adjustment 1280 on the exposure-normalized third image according to Equation 4 to generate an output image 1290 with an exposure similar to that of a target image.

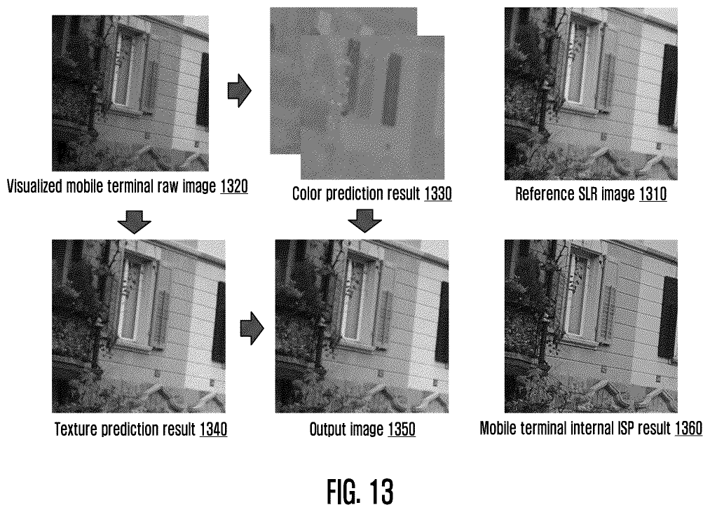

FIG. 13 shows color prediction results according to one or more example embodiments.

As shown in FIG. 13, on an input visualized raw image 1320 of a mobile terminal, a color prediction and a texture prediction may be performed, and then a color prediction result 1330 and a texture prediction result 1340 may be finally combined to obtain an output image 1350. The output image 1350, which is a final result according to the present disclosure, may be compared to an ISP result 1360 of the mobile terminal. In this case, the output image 1350 may be more approximate to a reference SLR image 1310 in terms of color and texture.

According to an example embodiment, there is provided a method of generating an SLR-quality image by performing ISP on an image of a mobile terminal device based on a depth and a a-priori guidance of an SLR image, which may include an a-priori SLR image-based color prediction module and a depth-based texture prediction module. According to an example embodiment, the method may be applied to an operation such as ISP of a mobile terminal camera to generate an SLR-quality sRGB image that is close to a color and texture distribution of a target device under the premise that only a raw domain image of a mobile terminal is used as an input.

In addition, according to an example embodiment, performing single image depth estimation as a secondary operation to allow a model to learn depth-related feature information during an encoding process and thereby learn a DOF of a target device from a current scene. In addition, an exposure of the target device may also be predicted based on an exposure difference in the scene. For a color prediction, an SLR image a-priori code table may be configured to learn a-priori information of the target device, and then a more accurate color prediction may be implemented through feature matching. Thus, the method of one or more embodiments may better simulate a sharpness-blur distribution of a target image during a mapping process from an image of the mobile terminal to an image of the SLR device, and at the same time may predict a color distribution closer to that of the target device to generate an image that is more suitable for visual laws of human eyes.

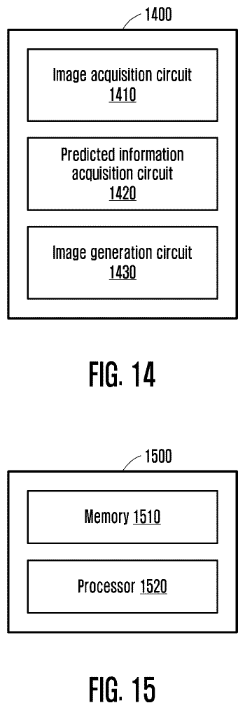

FIG. 14 illustrates an example of an electronic device 1400 according to one or more example embodiments. The electronic device 1400 may be a terminal, a server, or any other device.

As shown in FIG. 14, the electronic device 1400 may include an image acquisition circuit 1410, a predicted information acquisition circuit 1420, and an image generation circuit 1430.

The image acquisition circuit 1410 may be configured to obtain a first image.

The predicted information acquisition circuit 1420 may be configured to obtain predicted texture information of a target image corresponding to the first image through a texture prediction model based on the first image, and obtain predicted color information of the target image through a color prediction model based on the first image.

The image generation circuit 1430 may be configured to generate the target image based on the first image, using the predicted texture information and the predicted color information.

The format of the target image may be different from that of the first image.

In an example embodiment, the predicted information acquisition circuit 1420 may be configured to encode the first image through a first encoder of the texture prediction model to obtain an encoded image feature of the first image; decode the encoded image feature of the first image through a first decoder of the texture prediction model to obtain a first predicted image; and perform a texture extraction operation on the first predicted image through a texture extraction module to obtain the predicted texture information of the target image.

In an example embodiment, the texture prediction model may input training data into the first encoder and encode the training data to obtain an encoded image feature of the training data; input the encoded image feature into the first decoder of the texture prediction model and a second decoder of the texture prediction model, respectively, to obtain predicted texture information corresponding to the training data through the first decoder and obtain predicted depth information through the second decoder; train the first encoder and the first decoder with the predicted texture information corresponding to the training data and a reference image corresponding to the training data; and train the first encoder and the second decoder based on the obtained predicted depth information and a depth map obtained through a depth model.

In this case, the format of the training data may be the same as that of the first image, and the training data and the reference image may be obtained by different image sensors.

In an example embodiment, the depth map may be a depth map corresponding to the training data, which is obtained by performing relative depth estimation on an entire scene corresponding to the training data through the depth model.

In an example embodiment, the predicted information acquisition circuit 1420 may be configured to extract a feature of the first image through a second encoder of the color prediction model based on the first image; match the feature of the first image with a discrete code table including a-priori information of the reference image through the color prediction model; reconstruct the matched feature through a third decoder of the color prediction model to generate a second predicted image; and perform a color space transformation on the second predicted image and determine a color component of a result obtained by the color space transformation to be the predicted color information.

In an example embodiment, the color prediction model may be generated by training the third decoder and the discrete code table based on the reference image and training the second encoder based on the training data through the trained discrete code table and the trained third decoder. In this case, the reference image and the training data may be obtained by different image sensors.

In an example embodiment, the predicted information acquisition circuit 1420 may be configured to input the reference image into the second encoder to extract a feature of the reference image; match the feature of the reference image with a previous discrete code table; reconstruct the matched feature using the third decoder; and train the discrete code table and the third decoder based on the reference image and an image obtained after the reconstruction.

In an example embodiment, the predicted information acquisition circuit 1420 may be configured to input the training data into the second encoder to extract a feature of the training data; match the feature of the training data with the discrete code table obtained through the training; reconstruct the matched feature using the third decoder obtained through the training; and train the third decoder according to the reference image corresponding to the training data and an image obtained after the reconstruction.

In an example embodiment, the predicted information acquisition circuit 1420 may be further configured to obtain semantic information of the reference image; and semantically match the semantic information with a feature that is matched with the previous discrete code table among features of the reference image.

In this case, reconstructing the matched feature using the third decoder may include reconstructing a feature after the semantic matching using the third decoder.

In an example embodiment, the electronic device 1400 may further include an exposure adjustment circuit (not shown) that may be configured to perform fusion processing on the predicted texture information and the predicted color information to obtain a first fused image; obtain a first exposure parameter through an exposure estimation model based on the first fused image; and perform an exposure adjustment on the first fused image based on the first exposure parameter to obtain the target image.

In an example embodiment, before the texture prediction and the color prediction are performed, it may perform exposure normalization processing on the first image for each color channel to obtain an exposure-normalized first image.

In an example embodiment, the exposure adjustment circuit may be configured to estimate a second exposure parameter through the exposure estimation model based on the first image. The image generation circuit 1430 may be configured to generate an exposure-normalized third image based on the exposure-normalized first image, using the predicted texture information and the predicted color information, and perform an exposure adjustment on the exposure-normalized third image using the second exposure parameter to obtain the target image.

FIG. 15 illustrates an example of an electronic system 1500 according to one or more example embodiments.

As shown in FIG. 15, the electronic system 1500 may include a memory 1510 (e.g., one or more memories) and a processor 1520 (e.g., one or more processors).

The memory 1510 may be configured to store instructions.

The processor 1520 may be connected to the memory 1510 and configured to execute the instructions to cause the electronic system 1500 to perform any of the above methods. For example, the memory 1510 may include a non-transitory computer-readable storage medium storing instructions that, when executed by the processor 1520, configure the processor 1520 to perform any one, any combination, or all of the operations and/or methods disclosed herein with reference to FIGS. 1-14.

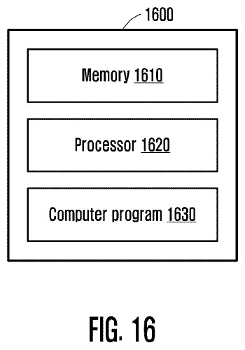

FIG. 16 illustrates an example of an electronic device 1600 according to one or more example embodiments. The electronic device 1600 may be a terminal, a server, or any other device.

As shown in FIG. 16, the electronic device 1600 may include a memory 1610 (e.g., one or more memories), a processor 1620 (e.g., one or more processors), and a computer program 1630 stored in the memory 1610, and the processor 1620 may execute the computer program 1630 to implement any of the above methods.

According to an example embodiment, there is further provided a computer-readable storage medium on which a computer program (e.g., the computer program 1630) is stored. When executed by a processor (e.g., the processor 1620), the computer program may implement the method described in any one of the appended claims. For example, the memory 1610 may include a non-transitory computer-readable storage medium storing the computer program 1630 that, when executed by the processor 1620, configure the processor 1620 to perform any one, any combination, or all of the operations and/or methods disclosed herein with reference to FIGS. 1-15.

An artificial intelligence (AI) model may be implemented by at least one of a plurality of modules. In this case, AI-related functions may be performed by a non-volatile memory, a volatile memory, and the processor.

The processor may include one or more processors. In this case, the one or more processors may be a general-purpose processor (e.g., a central processing unit (CPU), an application processor (AP), etc.) and/or a pure graphics processing unit (e.g., a graphics processing unit (GPU) and a visual processing unit (VPU)), and/or an AI-specific processor (e.g., a neural processing unit (NPU)).

The one or more processors may control an operation of processing input data according to predefined operational rules or AI models stored in the non-volatile memory and the volatile memory. The predefined operational rules or AI models may be provided by training or learning.

In this case, providing by learning may indicate applying a learning algorithm to a plurality of sets of training data to obtain the predefined operational rules or AI models having a desired characteristic. This learning may be performed on a device or electronic device itself on which AI is executed according to example embodiments, and/or may be implemented by a separate server, device, or system.

An AI model may include a plurality of neural network layers. Each layer may have a plurality of weight values, and each layer may perform a neural network computation by performing computations between input data of a layer (e.g., a computational result of a previous layer and/or input data of the AI model) and a plurality of weight values of the current layer. A neural network may include, but is not limited to, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network.

The learning algorithm may refer to a method of training a predetermined target device (e.g., a robot) using a plurality of sets of training data to guide, permit, or control the target device to perform determination and prediction. The learning algorithm may include, but is not limited to, supervised learning, unsupervised learning, semi-supervised learning, or reinforcement learning.

The modules, color prediction modules, texture prediction modules, exposure prediction modules, encoders, first encoders, decoders, first decoders, second decoders, texture extraction modules, second encoders, third decoders, electronic devices, circuits, image acquisition circuits, predicted information acquisition circuits, image generation circuits, electronic systems, memories, processors, color prediction module 440, texture prediction module 450, exposure prediction module 460, first encoder 710, first decoder 730, second decoder 740, texture extraction module 750, second encoder 910, third decoder 920, second encoder 930, third decoder 940, electronic device 1400, image acquisition circuit 1410, predicted information acquisition circuit 1420, image generation circuit 1430, electronic system 1500, memory 1510, processor 1520, electronic device 1600, memory 1610, and processor 1620 described herein, including descriptions with respect to respect to FIGS. 1-16, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-16 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with image generation, the method comprising:
obtaining a first image;
determining predicted texture information of a target image corresponding to the first image through a texture prediction model, based on the first image;
determining predicted color information of the target image through a color prediction model, based on the first image; and
generating the target image based on the first image, using the predicted texture information and the predicted color information,
wherein a format of the target image is different from that of the first image.

2. The method of claim 1, wherein the determining of the predicted texture information of the target image through the texture prediction model, based on the first image, comprises:
generating an encoded image feature of the first image by encoding the first image through a first encoder of the texture prediction model;
generating a first predicted image by decoding the encoded image feature of the first image through a first decoder of the texture prediction model; and
performing a texture extraction operation on the first predicted image through a texture extraction model to determine the predicted texture information of the target image.

3. The method of claim 2, wherein the texture prediction model is trained by:
generating an encoded image feature of training data by inputting the training data into the first encoder and encoding the training data;
determining predicted texture information corresponding to the training data through the first decoder of the texture prediction model and determining predicted depth information through a second decoder of the texture prediction model, by inputting the encoded image feature into each of the first decoder and the second decoder; and
training the first encoder and the first decoder through the predicted texture information corresponding to the training data and a reference image corresponding to the training data, and training the first encoder and the second decoder based on the determined predicted depth information and a depth map generated through a depth model,
wherein the training data is of the same format as the first image, and
the training data and the reference image are generated by different image sensors.

4. The method of claim 3, wherein the depth map is generated by performing relative depth estimation on an entire scene corresponding to the training data through the depth model and generating a depth map corresponding to the training data.

5. The method of claim 1, wherein the determining of the predicted color information of the target image through the color prediction model, based on the first image, comprises:
extracting a feature of the first image through a second encoder of the color prediction model, based on the first image;
matching the feature of the first image with a discrete code table comprising a-priori information of a reference image, through the color prediction model;
generating a second predicted image by reconstructing the matched feature through a third decoder of the color prediction model; and
performing a color space transformation on the second predicted image and determining, to be the predicted color information, a color component of a result generated by the color space transformation.

6. The method of claim 5, wherein the color prediction model is trained by:
training the third decoder and the discrete code table based on the reference image; and
training the second encoder through the trained discrete code table and the trained third decoder, based on training data,
wherein the reference image and the training data are generated by different image sensors.

7. The method of claim 6, wherein the training of the third decoder and the discrete code table based on the reference image comprises:
extracting a feature of the reference image by inputting the reference image into the second encoder;
matching the feature of the reference image with a previous discrete code table; and
reconstructing the matched feature using the third decoder, and training the discrete code table and the third decoder based on the reference image and an image generated after the reconstructing.

8. The method of claim 6, wherein the training of the second encoder through the trained discrete code table and the trained third decoder based on the training data comprises:
extracting a feature of the training data by inputting the training data into the second encoder;
matching the feature of the training data with the discrete code table determined by training; and
reconstructing the matched feature using the third decoder determined by training, and training the third decoder based on a reference image corresponding to the training data and an image generated after the reconstructing.

9. The method of claim 6, further comprising:
obtaining semantic information of the reference image; and
semantically matching the semantic information with a feature of the reference image that matches a previous discrete code table,
wherein the reconstructing of the matched feature using the third decoder comprises:
reconstructing a feature after the semantically matching using the third decoder.

10. The method of claim 1, wherein the generating of the target image based on the first image using the predicted texture information and the predicted color information comprises:
generating a first fused image by performing fusion processing on the predicted texture information and the predicted color information;
determining a first exposure parameter through an exposure estimation model based on the first fused image; and
performing an exposure adjustment on the first fused image based on the first exposure parameter to generate the target image.

11. The method of claim 1,
further comprising generating an exposure-normalized first image by performing exposure normalization processing on the first image for each color channel,
wherein the determining of the predicted texture information and the determining of the predicted color information are based on the exposure-normalized first image.

12. The method of claim 11, further comprising:
estimating a second exposure parameter from the first image through an exposure estimation model,
wherein the generating of the target image based on the first image using the predicted texture information and the predicted color information comprises:
generating an exposure-normalized third image based on the exposure-normalized first image, using the predicted texture information and the predicted color information; and
performing an exposure adjustment on the exposure-normalized third image, using the second exposure parameter, to generate the target image.

13. A non-transitory computer-readable storage medium storing instructions that, when executed by one or more processors, configure the one or more processors to perform the method of claim 1.

14. An electronic device, comprising:
one or more processors configured to:
obtain a first image;
determine predicted texture information of a target image corresponding to the first image and having a format different from that of the first image, through a texture prediction model, based on the first image;
determine predicted color information of the target image through a color prediction model, based on the first image; and
generate the target image based on the first image, using the predicted texture information and the predicted color information.

15. The electronic device of claim 14, wherein the one or more processors are configured to, for the determining of the predicted texture information of the target image through the texture prediction model, based on the first image:
generate an encoded image feature of the first image by encoding the first image through a first encoder of the texture prediction model;
generate a first predicted image by decoding the encoded image feature of the first image through a first decoder of the texture prediction model; and
perform a texture extraction operation on the first predicted image through a texture extraction module to determine the predicted texture information of the target image.

16. The electronic device of claim 14, wherein the one or more processors are configured to, for the determining of the predicted color information of the target image through the color prediction model, based on the first image:
extract a feature of the first image through a second encoder of the color prediction model, based on the first image;
match the feature of the first image with a discrete code table comprising a-priori information of a reference image, through the color prediction model;
generate a second predicted image by reconstructing the matched feature through a third decoder of the color prediction model; and
perform a color space transformation on the second predicted image and determine, to be the predicted color information, a color component of a result obtained by the color space transformation.

17. The electronic device of claim 14, wherein the one or more processors are configured to, for generating the target image based on the first image, using the predicted texture information and the predicted color information:
generate a first fused image by performing fusion processing on the predicted texture information and the predicted color information;
determine a first exposure parameter through an exposure estimation model based on the first fused image; and
perform an exposure adjustment on the first fused image based on the first exposure parameter to generate the target image.

18. The electronic device of claim 14, wherein the one or more processors are configured to:
generate an exposure-normalized first image by performing exposure normalization processing on the first image for each color channel, and
for the determining of the predicted texture information and the determining of the predicted color information, determine the predicted texture information and determine the predicted color information based on the exposure-normalized first image.

19. A processor-implemented method with image generation, the method comprising:
determining, based on a first image, predicted texture information of a target image corresponding to the first image and having a different format than the first image, using a texture prediction model;
determining, based on the first image and a discrete code table predetermined based on a reference image of the second format, predicted color information of the target image, using a color prediction model; and
generating the target image based on the predicted texture information and the predicted color information.

20. The method of claim 19,
further comprising determining, based on the predicted texture information and the predicted color information, predicted exposure information of the target image,
wherein the generating the target image further comprises generating the target image based on the predicted exposure information.
